(19) United States
(12) Patent Application Publication
(10) Pub. No.: US 2025/0271082 A1
(43) Pub. Date: Aug. 28, 2025

(54) ASSEMBLY FOR ENSURING ATTACHMENT

(71) Applicant: GM GLOBAL TECHNOLOGY OPERATIONS LLC, Detroit, MI (US)

(72) Inventors: Jesus Reyes Garcia, Zinacantepec (MX); Julio Alberto Velez, Toluca de Lerdo (MX); Gabriel Fernandez Davila, Lerma (MX); Sergio Cortes Fabela, Temixco (MX)

(73) Assignee: GM GLOBAL TECHNOLOGY OPERATIONS LLC, Detroit, MI (US)

(21) Appl. No.: 18/587,312

(22) Filed: Feb. 26, 2024

(51) Int. Cl. F16L 3/12; B60K 11/02

(52) U.S. Cl. CPC F16L 3/1222; B60K 11/02; F16L 2201/60

(57) ABSTRACT

Attachment assemblies, vehicles with attachments assemblies, and methods for ensuring attachment are disclosed. A method includes providing an attachment assembly in an initial configuration. The attachment assembly includes a first component having a scannable feature and a second component having a shield portion and a window. In the initial configuration, the scannable feature is received within the second component and the shield portion covers the scannable feature. The method further includes advancing the attachment assembly in a first direction into contact with an attachment feature such that the first component abuts the attachment feature while the second component continues moving in the first direction relative to the first component until the attachment assembly is in an attached configuration in which the scannable feature is revealed by the window; and scanning the scannable feature through the window with a scanner to confirm that the attachment assembly has been attached.

### INTRODUCTION

The disclosure relates to attachment features for vehicles, and may in particular relate to assemblies for ensuring proper attachment between two components.

The battery is the main energy source of an electric vehicle (EV) that supplies the power to propel the vehicle and to power other auxiliary systems. The performance of the battery is greatly influenced by its operating temperature. For example, certain battery types are required to operate at a temperature of from 20 to 40° C. To cool the battery for proper operation, a cooling system must maintain a proper flow rate and pressure of coolant at the inlet and outlet of the battery.

A coolant hose is used to deliver and remove coolant from the battery. The coolant hose is secured to the vehicle to prevent improper positioning, kinks, or damage to the hose. Therefore, attachment of the hose within the vehicle is important to maintain effective cooling of the battery and proper operation of the vehicle.

Accordingly, it is desirable to provide new and improved methods and assemblies for ensuring attachment of vehicle components, such as coolant hoses. Furthermore, other desirable features and characteristics of the present disclosure will become apparent from the subsequent detailed description and the appended claims, taken in conjunction with the accompanying drawings and the foregoing technical field and background.

### SUMMARY

In an embodiment, a method for ensuring attachment is provided. The method includes providing an attachment assembly in an initial configuration. The attachment assembly includes a first component having a scannable feature; and a second component having a shield portion and a window. In the initial configuration, the scannable feature is received within the second component and the shield portion covers the scannable feature. The method further includes advancing the attachment assembly in a first direction into contact with an attachment feature such that the first component abuts the attachment feature while the second component continues moving in the first direction relative to the first component until the attachment assembly is in an attached configuration in which the scannable feature is revealed by the window; and scanning the scannable feature through the window with a scanner to confirm that the attachment assembly has been attached to the attachment feature.

In certain embodiments, the method further includes communicating a signal from the scanner indicating that the attachment assembly has been attached to the attachment feature.

In certain embodiments of the method, the second component includes a body portion connected to a ring portion, and the method further includes surrounding a hose with the ring portion.

In certain embodiments of the method, the second component includes a body portion connected to a ring portion, and the method further includes surrounding a hose with the ring portion before advancing the attachment assembly in the first direction into contact with the attachment feature and before scanning the scannable feature through the window with the scanner to confirm that the attachment assembly has been attached to the attachment feature.

In certain embodiments of the method, the first component includes a first locking feature; the second component includes a second locking feature; and the method includes locking the attachment assembly in the attached configuration by engaging the first locking feature and the second locking feature.

In certain embodiments of the method, the first component includes a first retaining feature; the second component includes a second retaining feature; and the method includes retaining the attachment assembly in the initial configuration by engaging the first retaining feature and the second retaining feature until a force from advancing the attachment assembly in the first direction while the first component abuts the attachment feature causes the first retaining feature and the second retaining feature to disengage.

In certain embodiments of the method, the attachment feature includes a surface formed with a hole; the second component includes a distal projection; advancing the attachment assembly in the first direction includes inserting the distal projection into the hole; advancing the attachment assembly in the first direction is continued until the shield portion abuts the surface; the attachment assembly is in the attached configuration when the shield portion abuts the surface; and while advancing the attachment assembly in the first direction the first component abuts the surface.

In certain embodiments of the method, the surface is a first surface of a wall; the wall has an opposite second surface; the hole extends through the wall; the distal projection includes a deformable radially-outward extension; advancing the attachment assembly in the first direction including deforming the deformable radially-outward extension to pass through the hole; and the deformable radially-outward extension extends outward after passing through the hole and prevents removal of the distal projection from the hole.

In certain embodiments of the method, the attachment feature includes a stud extending from a surface; the second component includes an inward-extending arm; advancing the attachment assembly in the first direction includes contacting the inward-extending arm with the stud; advancing the attachment assembly in the first direction is continued until the shield portion abuts the surface; and the attachment assembly is in the attached configuration when the shield portion abuts the surface.

In certain embodiments of the method, the inward-extending arm includes a plurality of inward-extending arms that define a central passageway; and while advancing the attachment assembly in the first direction a distal portion of the stud extends through the central passageway.

In another embodiment, an attachment assembly is provided and includes a first component having a scannable feature; and a second component having a shield portion and a window. The first component is movable relative to the second component in a first direction from an initial configuration to an attached configuration. In the initial configuration the scannable feature is received within the second component and the shield portion covers the scannable feature. In the attached configuration, the scannable feature is revealed by the window.

In certain embodiments of the attachment assembly, the first component includes a first locking feature; the second component includes a second locking feature; and the first locking feature is configured to engage the second locking feature to lock the attachment assembly in the attached configuration.

In certain embodiments of the attachment assembly, the first component includes a first retaining feature; the second component includes a second retaining feature; and the first retaining feature is configured to hold the second retaining feature in the initial configuration and to release the second retaining feature upon application of a force in the first direction.

In certain embodiments of the attachment assembly, the second component includes a distal projection extending in a second direction opposite the first direction and configured for insertion in a hole in a wall; and the distal projection includes a deformable radially-outward extension configured to engage a backside of the wall.

In certain embodiments of the attachment assembly, the second component includes inward-extending arms that terminate at a central passageway.

In another embodiment, a vehicle is provided and includes a coolant system including a hose; and an attachment assembly including a first component having a scannable feature and a second component including a ring portion engaging the hose and having a shield portion and a window. The first component is movable relative to the second component in a first direction from an initial configuration to an attached configuration. In the initial configuration the scannable feature is received within the second component and the shield portion covers the scannable feature. In the attached configuration, the scannable feature is revealed by the window.

In certain embodiments, the vehicle further includes a wall formed with a hole extending from a first surface of the wall to an opposite second surface of the wall, the second component includes a distal projection extending through the hole, the distal projection includes a radially-outward extension having a diameter greater than a diameter of the hole, the shield portion abuts the first surface of the wall, and the first component abuts the first surface of the wall.

In certain embodiments, the vehicle further includes a stud extending from a surface, the second component includes inward-extending arms that terminate at a central passageway, the stud passes through the central passageway, and the first component abuts the surface.

In certain embodiments of the vehicle, the first component includes a first locking feature, the second component includes a second locking feature, and the first locking feature is configured to engage the second locking feature to lock the attachment assembly in the attached configuration.

In certain embodiments of the vehicle, the first component includes a first retaining feature, the second component includes a second retaining feature, and the first retaining feature is configured to hold the second retaining feature in the initial configuration and to release the second retaining feature upon application of a force in the first direction.

### DESCRIPTION OF THE DRAWINGS

The present disclosure will hereinafter be described in conjunction with the following drawing figures, wherein like numerals denote like elements, and wherein:

FIG. 1 is a schematic layout of a vehicle having a cooling system in accordance with exemplary embodiments;

FIG. 2 is a perspective view schematic of the attachment of a coolant hose of FIG. 1 with an attachment assembly in accordance with exemplary embodiments;

FIG. 3 is a perspective view schematic of a portion of a ring portion of the attachment assembly of FIG. 2 in accordance with certain embodiments;

FIG. 4 is a perspective view schematic of an outer member of the attachment assembly of FIG. 2 in accordance with certain embodiments;

FIG. 5 is a perspective view schematic of an inner member of the attachment assembly of FIG. 2 in accordance with certain embodiments;

FIG. 6 is a side view schematic of the attachment assembly of FIG. 2 in an initial configuration before contact with an attachment feature in accordance with certain embodiments;

FIG. 7 is a side view schematic of the attachment assembly of FIG. 2 in an attached configuration and in engagement with an attachment feature in accordance with certain embodiments;

FIG. 8 is a perspective view schematic of the attachment of a coolant hose of FIG. 1 with an attachment assembly in accordance with exemplary embodiments;

FIG. 9 is a perspective view schematic of a portion of a ring portion and fastener member of the attachment assembly of FIG. 8 in accordance with certain embodiments;

FIG. 10 is a perspective view schematic of an outer member of the attachment assembly of FIG. 8 in accordance with certain embodiments;

FIG. 11 is a perspective view schematic of an inner member of the attachment assembly of FIG. 8 in accordance with certain embodiments;

FIG. 12 is a side view schematic of the attachment assembly of FIG. 8 in an initial configuration before contact with an attachment feature in accordance with certain embodiments;

FIG. 13 is a side view schematic of the attachment assembly of FIG. 8 in an initial configuration upon contact with an attachment feature in accordance with certain embodiments;

FIG. 14 is a side view schematic of the attachment assembly of FIG. 8 in an attached configuration and in engagement with an attachment feature in accordance with certain embodiments, and

FIG. 15 is a flow chart illustrating a method for ensuring attachment in accordance with certain embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, brief summary or the following detailed description. As used herein, the term “module” refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Embodiments herein provide for ensuring attachment between components, such as in a vehicle. In certain embodiments, a hose is encircled or surrounded by a ring member of an attachment assembly. The attachment assembly further includes components configured to be mounted to an attachment feature of the vehicle. The attachment assembly includes a scannable feature that may be scanned after the attachment assembly is properly installed and connects the components. For example, the attachment assembly has an initial configuration that covers or hides the scannable feature. The attachment assembly further has an attached configuration in which the assembly uncovers or reveals the scannable feature. The attachment assembly may self-lock itself in the attached configuration. As a result, proper connection between two components may be evaluated by reviewing scanned scannable features.

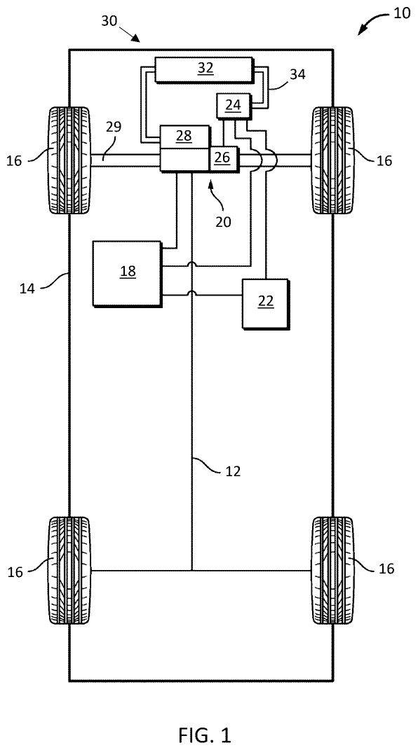

With reference to FIG. 1, certain features of a vehicle 10 are illustrated in functional block diagram form. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The vehicle 10 may also incorporate any one of, or combination of, a number of different types of engines, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine (i.e., such as in a hybrid electric vehicle (HEV)), and an electric motor.

As depicted in FIG. 1, the exemplary vehicle 10 generally includes a chassis 12, a body 14, four wheels 16, and an electronic control system 18. The body 14 is arranged on the chassis 12 and substantially encloses the other components of the vehicle 10. The body 14 and the chassis 12 may jointly form a frame. The wheels 16 are each rotationally coupled to the chassis 12 near a respective corner of the body 14.

In the exemplary embodiment illustrated in FIG. 1, the vehicle 10 includes an actuator assembly 20, a battery (or a DC power supply) 22, and a power converter assembly (e.g., an inverter or inverter assembly) 24. The actuator assembly 20 may include an electric motor/generator (or motor) 26 and/or a combustion engine 28.

Still referring to FIG. 1, the electric motor 26 and the combustion engine 28 are integrated such that one or both are mechanically coupled to at least some of the wheels 16 through one or more drive shafts 29.

The vehicle 10 further includes a thermal management system 30 including a radiator 32 and coolant circulation hoses 34. The radiator 32 may be connected to the frame at an outer portion thereof. The coolant circulation hoses 34 may provide multiple cooling channels that contain a cooling fluid (i.e., coolant) such as water and/or ethylene glycol (i.e., “antifreeze”). The coolant circulation hoses 34 may be coupled to the combustion engine 28 and/or the inverter 24. In certain embodiments, these components control the temperature of the battery 22, inverter 24, and motor 26 to provide optimal performance.

Referring again to FIG. 1, in the depicted embodiment, the inverter 24 receives and shares coolant with the electric motor 26. However, other embodiments may use separate coolants for the inverter 24 and the electric motor 26. The radiator 32 may be similarly connected to the inverter 24 and/or the electric motor 26.

The electronic control system 18 is in operable communication with the actuator assembly 20, the high voltage battery 22, and the inverter 24. Although not shown in detail, the electronic control system 18 includes various sensors and automotive control modules, or electronic control units (ECUs), such as an inverter control module, a motor controller, and a vehicle controller, and at least one processor and/or a memory.

In electric vehicles (EVs) 10, the failure to appropriately circulate coolant may represent an overheating situation that may lead to a loss of propulsion during vehicle operation. Therefore, a high confidence attachment may be used to prevent the coolant circulation hose 34 from becoming loose and being punctured or otherwise forming a leak.

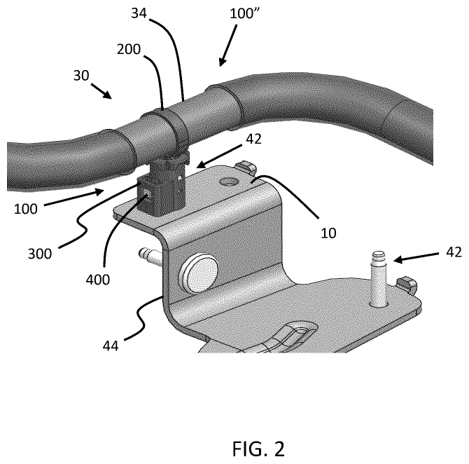

Referring to FIG. 2, an exemplary coolant circulation hose 34 of the thermal management system 30 is shown mounted to a portion of the vehicle 10. Specifically, in the illustrated embodiment, the hose 34 is mounted to an attachment feature 42 on a component 44 of the vehicle 10.

As shown in FIG. 2, an attachment assembly 100 is used to mount the coolant circulation hose 34 to the attachment feature 42. The attachment assembly 100 may include multiple portions or components, such as a ring member 200, a base or outer member 300, and an inner member 400, that are connected together to provide a method for ensuring that the coolant circulation hose 34 is properly mounted to the component 44 of the vehicle 10. In FIG. 2, the attachment assembly 100 is shown in an attached configuration 100″.

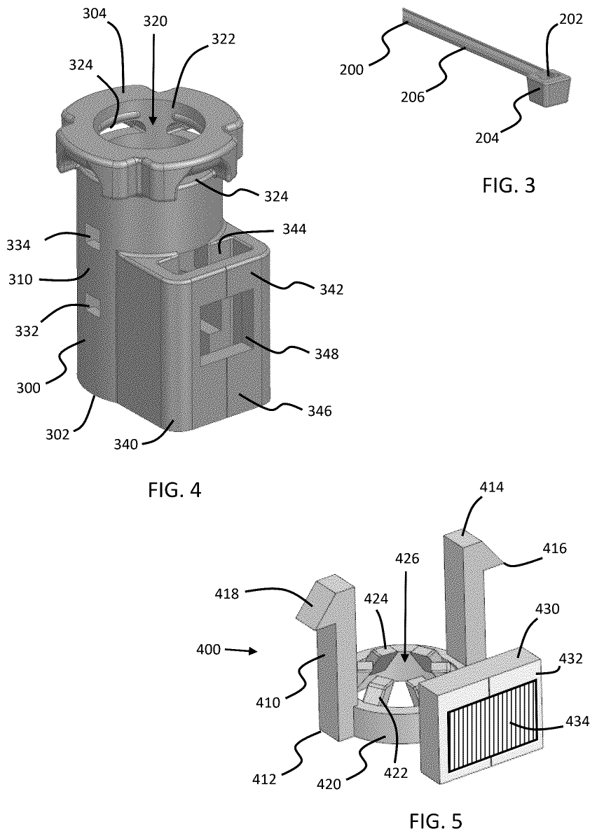

FIGS. 3-5 separately illustrate each member 200, 300, and 400 of the attachment assembly 100 of FIG. 2, respectively.

In FIG. 3, a proximal portion of the ring member 200 is shown. As shown, an opening 202 is formed at a proximal end 204 of the ring member 200. The ring member 200 further includes a flexible body 206 that extends in a distal direction away from the proximal end 204 to a distal end (not shown). In FIG. 3, the ring member 200 is shown in an un-coupled configuration in which the flexible body 206 is not received within the opening 202. To engage a coolant circulation hose 34, the flexible body 206 may be looped around the hose 34 and the distal end thereof may be passed through the opening 202. In exemplary embodiments, the opening 202 and flexible body 206 are formed with cooperating structures to allow the flexible body 206 to be inserted into the opening 202 while preventing the flexible body 206 from being withdrawn from the opening 202.

In FIG. 4, an exemplary embodiment of the outer member 300 is illustrated. As shown, the outer member 300 includes a main portion 310 that extends from a bottom end 302 to a top end 304. The main portion 310 is annular and defines a vertically extending inner channel 320 in communication with a top opening 322 at the top end 304.

Adjacent to the top end 304, a pair of aligned slots 324 are provided to receive the flexible body 206 of the ring member 200 to allow attachment of the ring member 200 to the outer member 300. As shown, the outer member 300 may include an alternate pair of aligned slots offset by ninety degrees to allow the ring member 200 to be attached to the outer member 300 at a desired orientation.

The outer member 300 may be provided with a pair of opposite retaining features 332, such as openings. Further, the outer member 300 may be provided with a pair of opposite locking features 334, such as openings. In the illustrated embodiment, the retaining features 332 and locking features 334 are vertically aligned, with the retaining features 332 being located between the locking features 334 and the bottom end 302.

As shown, the outer member 300 further includes a window compartment 340 joined to the main portion 310. The window compartment 340 has an outer wall 342 that defines a vertically-extending inner channel 344. The inner channel 344 is covered by a shield portion 346 of the outer wall 342. Further, a window 348 is formed through the outer wall 342 and is open to the inner channel 344.

FIG. 5 illustrates an exemplary inner member 400. As shown, the inner member 400 may include vertically extending posts 410 that are connected to an annular body portion 420. Exemplary vertically extending posts 410 have some flexibility to allow deflection as described below.

Further, the inner member 400 may include a face portion 430 that is connected to the annular body portion 420 by a radially extending member (hidden in FIG. 5). The face portion 430 includes an outer surface 432 on which a scannable feature 434, such as indicia or a QR code, may be located.

As shown, the inner member 400 may include radially inward extending arms 422 connected to the annular body portion 420. The arms 422 may be circumferentially spaced on the annular body portion 420. Further, the arms 422 may terminate at distal ends 424 that define a central passageway 426 extending vertically through the inner member 400.

As shown in FIG. 5, the vertically extending posts 410 have a bottom end 412 that is connected to the annular body portion 420. The vertically extending posts 410 extend upward from the bottom end 412 to a top end 414. At the top end 414, the posts 410 are formed with radially outward extending projections 416. Each radially outward extending projection 416 has a sloping surface 418.

Cross-referencing FIGS. 3-5, it may be seen that the attachment assembly 100 of FIG. 2 may be assembled by receiving the inner member 400 within the outer member 300 and connecting the ring member 200 to the outer member 300.

For example, the posts 410 and annular body portion 420 are received within the vertically extending inner channel 320 in the main portion 310 of the outer member 300. Further, the face portion 430 of the inner member 400 is received within the vertically-extending inner channel 344 of the window compartment 340.

In an initial configuration, the radially outward extending projections 416 of the posts 410 are received in the retaining feature openings 332. In the initial configuration, the radially outward extending projections 416 of the posts 410 engage with the retaining feature openings 332 to prevent downward movement of the inner member 400 relative to the outer member 300, i.e., removal of the inner member 400 from the outer member 300.

Further, in the initial configuration, the scannable feature 434 on the face portion 430 is covered by the shield portion 346 of the outer wall 342 of the window compartment 340.

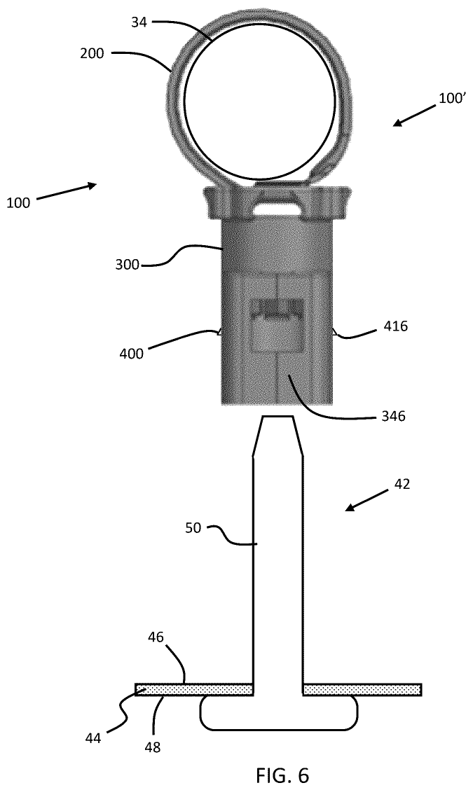

In FIG. 6, the attachment assembly 100 is shown in the initial configuration 100′ positioned over an attachment feature 42 of the vehicle 10. In the illustrated embodiment, the attachment feature 42 includes a stud 50 extending from a surface 46 of a component 44 of the vehicle 10. As shown, the component 44 may be a wall and have an opposite surface 48.

In FIG. 6, the radially outward extending projections 416 of the inner member 400 extend through the outer member 300 and are visible. As shown, the ring member 200 encircles the coolant circulation hose 34. As further shown, the shield portion 346 of the outer member 300 covers the scannable feature of the inner member 400 such that the scannable feature is not visible.

Further, the flexible body 206 is inserted through a pair of aligned slots 324. The flexible body 206 may be further inserted through the opening 202 at the proximal end 204 of the ring member 200 and tightened around the coolant circulation hose 34.

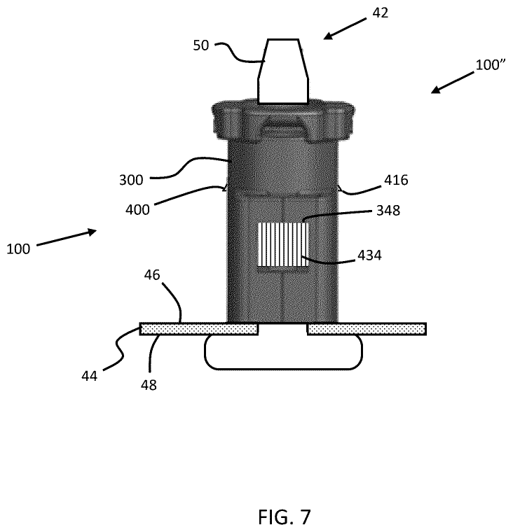

In FIG. 7, the attachment assembly 100 is shown after a downward force has pushed the attachment assembly 100 toward the vehicle component 44. The attachment assembly 100 is in the attached configuration 100″. The ring member 200 is not shown for purposes of clarity.

As the attachment assembly 100 is pressed downward, the stud 50 moves upward relative to the attachment assembly 100, and the stud 50 contacts the radially inward extending arms 422. Upon contact, the arms 422 may deflect upward. As the outer member 300 continues movement downward, friction between the stud 50 and the arms 422 causes the inner member 400 to remain stationary or slow. As a result, the sloping surfaces 418 of the posts 410 cause the radially outward projections 416 to retract within the outer member 300 and out of engagement with the retaining feature openings 332. The inner surface of the outer member 300 may be formed with channels that limit the radially outward projections 416 to vertical movement.

A downward force may cause the outer member 300 to continue moving downward until the outer member 300 contacts the surface 46 of the vehicle component 44. In other embodiments, downward movement of the outer member 300 may stop before contacting the surface 46 of the vehicle component 44.

As shown in FIG. 7, when relative movement between the outer member 300 and inner member 400 is sufficient, the radially outward projections 416 reach the locking feature openings 334 and extend outward, into the openings 334 and through the outer member 300. Engagement between the radially outward projections 416 and the locking feature openings 334 prevent downward movement of the inner member 400 relative to the outer member 300. Thus, the attachment assembly 100 is locked in the attached configuration 100″. Internal surfaces of the outer member 300 may abut the exterior surfaces of the inner member 400 in the attached configuration 100″ to prevent further upward movement of the inner member 400 relative to the outer member 300.

In FIG. 7, the distal end of the stud 50 extends out of the outer member 300. In other embodiments, the distal end of the stud 50 remains within the outer member 300.

In the attached configuration 100″, the scannable feature 434 is aligned with, and visible through, the window 348 in the outer member 300.

FIGS. 2-7 illustrate an embodiment of an attachment assembly 100 for use with an attachment feature 42 in the form of a projection like stud 50. In other embodiments, the attachment assembly 100 may be used with an attachment feature 42 in the form of a hole in surface.

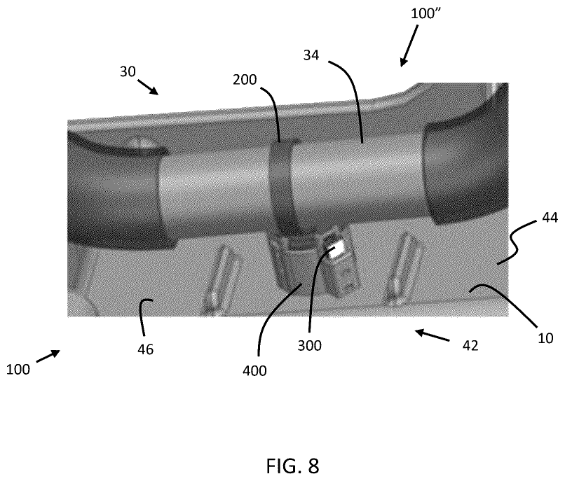

For example, as shown in FIG. 8, an exemplary attachment assembly 100 is illustrated in the attached configuration 100″. In FIG. 8, the attachment assembly 100 is attached to an attachment feature 42 in the form of a hole in a surface 46 of a vehicle component 44. As shown, the attachment assembly 100 includes a ring member 200, outer member 300, and inner member 400. The ring member 200 circumscribes a coolant circulation hose 34.

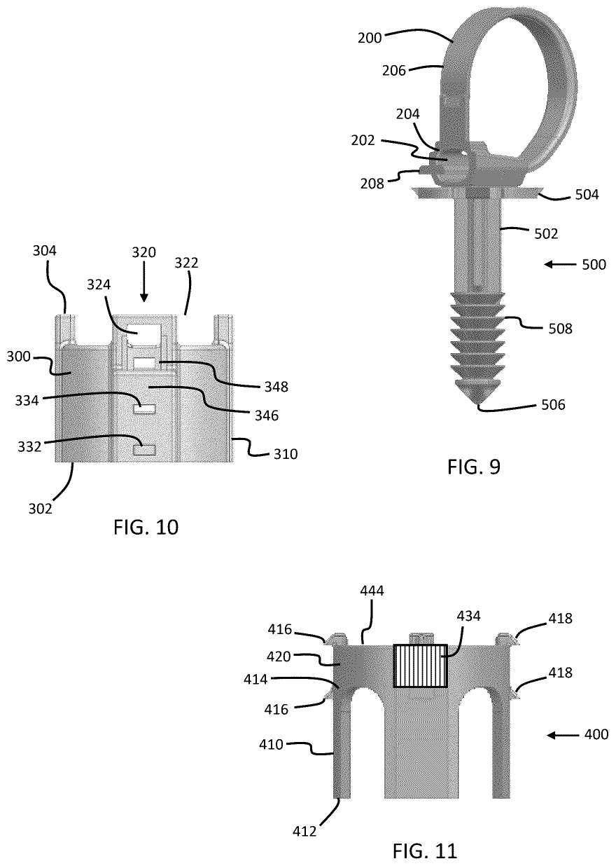

FIGS. 9-11 separately illustrate each member 200, 300, and 400 of the attachment assembly 100 of FIG. 8, respectively.

In FIG. 9, the ring member 200 is shown in connection with a projection or fastener member 500. As shown, the ring member 200 includes an opening 202 formed at a proximal end 204. The ring member 200 further includes a flexible body 206 that extends in a distal direction away from the proximal end 204 to a distal end 208. In FIG. 9, the ring member 200 is shown in a coupled configuration in which the distal end 208 is passed through the opening 202 and the flexible body 206 is received within the opening 202. Typically, the ring member 200 encircles a hose 34, which is not shown in FIG. 9. In exemplary embodiments, the opening 202 and flexible body 206 are formed with cooperating structures to allow the flexible body 206 to be inserted into the opening 202 while preventing the flexible body 206 from being withdrawn from the opening 202.

As shown, the ring member 200 is attached to a fastener member 500. The fastener member 500 may include a shaft portion 502 that extends distally from a head 504 to a distal end 506. As shown, radially outward extensions 508 are formed on the shaft portion 502 near the distal end 506. The radially outward extensions 508 may be rings around the shaft portion 502.

The ring member 200 may be attached to the fastener member 500 by passing through an opening (not visible in FIG. 9) formed on the head 504 of the fastener member 500. Alternatively, the proximal end 204 of the ring member 200 may be integral with, i.e., part of, the head 504 of the fastener member 500. In other embodiments, the ring member 200 and fastener member 500 are connected in other suitable manners.

In FIG. 10, an exemplary embodiment of the outer member 300 is illustrated. As shown, the outer member 300 includes a main portion 310 that extends from a bottom end 302 to a top end 304. The main portion 310 is annular and defines a vertically extending inner channel 320 in communication with a top opening 322 at the top end 304.

Adjacent to the top end 304, a pair of aligned slots 324 are provided and may receive the flexible body 206 of the ring member 200 or a portion of the head 504 of the fastener member 500 to allow attachment of the ring member 200 and fastener member 500 to the outer member 300. As shown, the outer member 300 may include an alternate pair of aligned slots offset by ninety degrees to allow the ring member 200 and/or fastener member 500 to be attached to the outer member 300 at a desired orientation.

The outer member 300 may be provided with a pair of opposite retaining features 332, such as openings. Further, the outer member 300 may be provided with a pair of opposite locking features 334, such as openings. In the illustrated embodiment, the retaining features 332 and locking features 334 are vertically aligned, with the retaining features 332 being located between the locking features 334 and the bottom end 302. In certain embodiments, a second set of locking features 334 are provided. In such an embodiment, the first set of locking features 334 may serve as retaining features in an attached configuration 100″ of the attachment assembly 100.

As shown, the outer member 300 includes a shield portion 346 that covers the inner channel 320. Further, a window 348 is formed in the outer member 300 and is open to the inner channel 320.

FIG. 11 illustrates an exemplary inner member 400. As shown, the inner member 400 may include vertically extending posts 410 that are connected to an annular body portion 420.

Further, the inner member 400 a scannable feature 434, such as indicia or a QR code, located on the annular body portion 420.

As shown in FIG. 11, the vertically extending posts 410 extend downward from a top end 414 at the annular body portion 420 to bottom ends 412. At the top end 414, the posts 410 are formed with radially outward extending projections 416. Each radially outward extending projection 416 has a sloping surface 418. In certain embodiments, a second set of radially outward extending projections 416 are formed at the top end 444 of the inner member 400, in vertical alignment with the lower set of radially outward extending projections 416.

Cross-referencing FIGS. 9-11, it may be seen that the attachment assembly 100 of FIG. 8 may be assembled by receiving the inner member 400 within the outer member 300 and connecting the ring member 200 to the outer member 300. For example, the inner member 400 is received within the vertically extending inner channel 320 of the outer member 300.

In an initial configuration, the radially outward extending projections 416 of the posts 410 are received in the lower retaining feature openings 332 and the upper radially outward extending projections 416 at the top end 444 are received in the upper retaining feature openings 332, i.e., in the lower locking feature openings 334. In the initial configuration, the radially outward extending projections 416 of the inner member 400 engage with the respective retaining feature openings 332 to prevent downward movement of the inner member 400 relative to the outer member 300, i.e., removal of the inner member 400 from the outer member 300.

Further, in the initial configuration, the scannable feature 434 on the inner member 400 is covered by the shield portion 346 of the outer member 300.

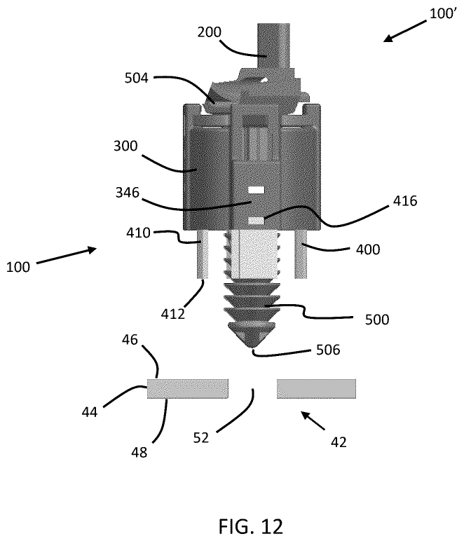

In FIG. 12, the attachment assembly 100 is shown in the initial configuration 100′ positioned over an attachment feature 42 of the vehicle 10. In the illustrated embodiment, the attachment feature 42 includes a hole 52 extending from a top surface 46 to a bottom surface 48 of a component 44 of the vehicle 10.

In FIG. 12, only a portion of the ring member 200 is illustrated for simplicity. As shown, the ring member 200 is joined to the head 504 of the fastener member 500.

In FIG. 12, the radially outward extending projections 416 of the inner member 400 extend through the outer member 300 and are visible. Further, the bottom ends 412 of the posts 410 extend below the outer member 300 and are visible. The distal end 506 of the fastener member 500 extends further below the bottom ends 412 of the posts 410.

As further shown, the shield portion 346 of the outer member 300 covers the scannable feature of the inner member 400 such that the scannable feature is not visible.

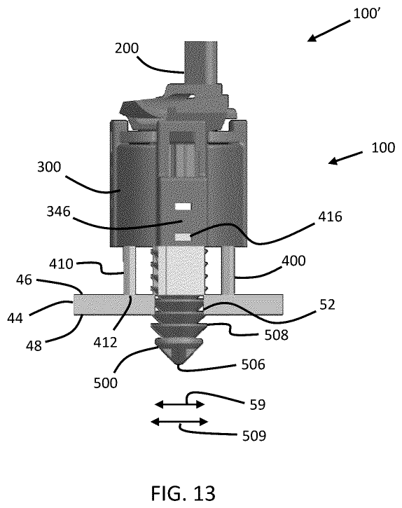

In FIG. 13, the attachment assembly 100 of FIG. 12 is shown after being brought into initial contact with the surface 46 of the vehicle component 44. Specifically, the attachment assembly 100 is lowered and the distal end 506 of the fastener member 500 is inserted into the hole 52 until the bottom ends 412 first contact the surface 46. At this stage, the attachment assembly 100 is still in the initial configuration 100′.

As shown, the radially outward extensions 508 may be flexible and may be deflected as the fastener member 500 is inserted into the hole 52. After passing through the hole 52, the radially outward extensions 508 extend back to their initial position. As a result, radially outward extensions 508 may contact the bottom surface 48 of the vehicle component 44 to hold the fastener member 500 in the hole 52. As shown, the radially outward extensions may have a diameter 509 that is greater than the diameter 59 of the hole 52.

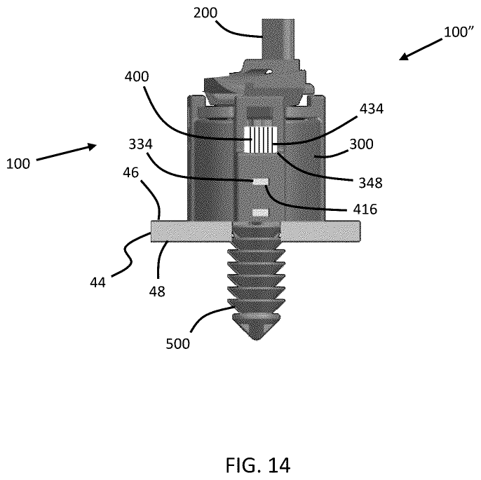

FIG. 14 illustrates the attachment assembly 100 of FIG. 12 in the attached configuration 100″, after a downward force has pushed the attachment assembly 100 toward the vehicle component 44.

As the attachment assembly 100 is pressed downward after initial contact of the bottom ends 412 of the inner member 400 and the surface 46, the inner member 400 is stationary while the outer member 300, ring member 200, and fastener member 500 move downward. As a result, the sloping surfaces 418 of the radially outward projections 416 cause the radially outward projections 416 to retract within the outer member 300 and out of engagement with the retaining feature openings 332. The inner surface of the outer member 300 may be formed with channels that limit the radially outward projections 416 to vertical movement.

The downward force may cause the outer member 300 to continue moving downward until the outer member 300 contacts the surface 46 of the vehicle component 44. In other embodiments, downward movement of the outer member 300 may stop before contacting the surface 46 of the vehicle component 44.

As shown in FIG. 14, when relative movement between the outer member 300 and inner member 400 is sufficient, the radially outward projections 416 reach the locking feature openings 334 and extend outward, into the openings 334 and through the outer member 300. Engagement between the radially outward projections 416 and the locking feature openings 334 prevent downward movement of the inner member 400 relative to the outer member 300. Thus, the attachment assembly 100 is locked in the attached configuration 100″. Internal surfaces of the outer member 300 may abut the exterior surfaces of the inner member 400 in the attached configuration 100″ to prevent further upward movement of the inner member 400 relative to the outer member 300.

In the attached configuration 100″, the scannable feature 434 is aligned with, and visible through, the window 348 in the outer member 300.

The embodiments of FIGS. 2-7 and 8-14 prevent scanning of the scannable feature 434 in the initial configuration 100′ of the attachment assembly 100, and allow scanning of the scannable feature 434 in the attached configuration 100″ of the attachment assembly 100. Specifically, in each embodiment, the shield portion of the outer member 300 covers the scannable feature 434 of the inner member 400 in the initial configuration 100′, and the window in the outer member 300 reveals the scannable feature 434 of the inner member 400 in the attached configuration 100″.

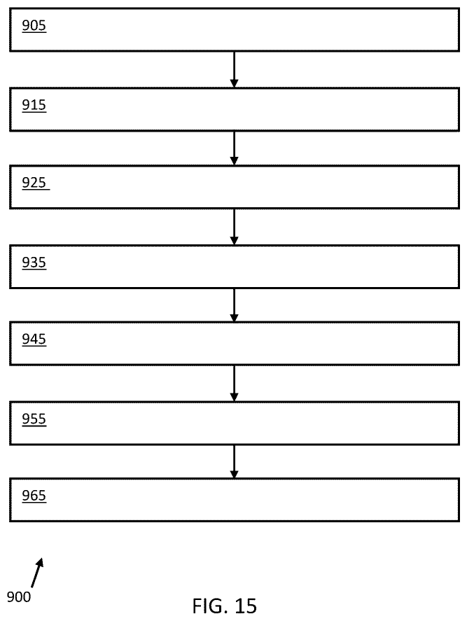

Referring now to FIG. 15, a flow chart of a method 900 for ensuring attachment is illustrated. As shown, method 900 includes, at operation 905, providing an attachment assembly in an initial configuration.

Method 900 further includes surrounding a coolant hose with the ring member of the attachment assembly at operation 915.

At operation 925, method 900 includes retaining the attachment assembly in the initial configuration, such as by engaging features of the inner member and outer member of the attachment assembly.

Method 900 includes, at operation 935, advancing the attachment assembly in a first direction into contact with an attachment feature such that one component of the attachment assembly abuts the attachment feature while a second component of the attachment assembly continues moving in the first direction relative to the first component until the attachment assembly is in an attached configuration in which the scannable feature is revealed by the window.

Method 900 may further include locking the attachment assembly in the attached configuration by engaging locking features of the inner member and outer member of the attachment assembly at operation 945.

At operation 955, method 900 includes scanning the scannable feature through the window of the outer member with a scanner to confirm that the attachment assembly has been attached to the attachment feature.

Method 900 may further include communicating a signal from the scanner indicating that the attachment assembly has been attached to the surface to a control module or processor at operation 965.

Embodiments described herein may eliminate use of threaded fastening, reducing the cost of parts. Further, embodiments described herein provide for a high level of detection for proper attachment, as the scannable feature cannot be scanned unless the attachment assembly is in the attached configuration. During manufacturing, a failure to scan all scannable features may result in a line stoppage to ensure that all attachments are properly performed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for ensuring attachment, the method comprising:
providing an attachment assembly in an initial configuration, wherein the attachment assembly comprises:
a first component having a scannable feature; and
a second component having a shield portion and a window, wherein, in the initial configuration the scannable feature is received within the second component and the shield portion covers the scannable feature;
advancing the attachment assembly in a first direction into contact with an attachment feature such that the first component abuts the attachment feature while the second component continues moving in the first direction relative to the first component until the attachment assembly is in an attached configuration in which the scannable feature is revealed by the window; and
scanning the scannable feature through the window with a scanner to confirm that the attachment assembly has been attached to the attachment feature.

2. The method of claim 1, further comprising communicating a signal from the scanner indicating that the attachment assembly has been attached to the attachment feature.

3. The method of claim 1, wherein the second component includes a body portion connected to a ring portion, and wherein the method further comprises surrounding a hose with the ring portion.

4. The method of claim 1, wherein the second component includes a body portion connected to a ring portion, and wherein the method further comprises surrounding a hose with the ring portion before advancing the attachment assembly in the first direction into contact with the attachment feature and before scanning the scannable feature through the window with the scanner to confirm that the attachment assembly has been attached to the attachment feature.

5. The method of claim 1, wherein:
the first component includes a first locking feature;
the second component includes a second locking feature; and
the method comprises locking the attachment assembly in the attached configuration by engaging the first locking feature and the second locking feature.

6. The method of claim 1, wherein:
the first component includes a first retaining feature;
the second component includes a second retaining feature; and
the method comprises retaining the attachment assembly in the initial configuration by engaging the first retaining feature and the second retaining feature until a force from advancing the attachment assembly in the first direction while the first component abuts the attachment feature causes the first retaining feature and the second retaining feature to disengage.

7. The method of claim 1, wherein:
the attachment feature includes a surface formed with a hole;
the second component includes a distal projection;
advancing the attachment assembly in the first direction includes inserting the distal projection into the hole;
advancing the attachment assembly in the first direction is continued until the shield portion abuts the surface;
the attachment assembly is in the attached configuration when the shield portion abuts the surface; and
while advancing the attachment assembly in the first direction the first component abuts the surface.

8. The method of claim 7, wherein:
the surface is a first surface of a wall;
the wall has an opposite second surface;
the hole extends through the wall;
the distal projection includes a deformable radially-outward extension;
advancing the attachment assembly in the first direction comprising deforming the deformable radially-outward extension to pass through the hole; and
the deformable radially-outward extension extends outward after passing through the hole and prevents removal of the distal projection from the hole.

9. The method of claim 1, wherein:
the attachment feature includes a stud extending from a surface;
the second component includes an inward-extending arm;
advancing the attachment assembly in the first direction includes contacting the inward-extending arm with the stud;
advancing the attachment assembly in the first direction is continued until the shield portion abuts the surface; and
the attachment assembly is in the attached configuration when the shield portion abuts the surface.

10. The method of claim 9 wherein:
the inward-extending arm comprises a plurality of inward-extending arms that define a central passageway; and
while advancing the attachment assembly in the first direction a distal portion of the stud extends through the central passageway.

11. An attachment assembly comprising:
a first component having a scannable feature; and
a second component having a shield portion and a window:
wherein:
the first component is movable relative to the second component in a first direction from an initial configuration to an attached configuration;
in the initial configuration the scannable feature is received within the second component and the shield portion covers the scannable feature; and
in the attached configuration, the scannable feature is revealed by the window.

12. The attachment assembly of claim 11, wherein:
the first component includes a first locking feature;
the second component includes a second locking feature; and
the first locking feature is configured to engage the second locking feature to lock the attachment assembly in the attached configuration.

13. The attachment assembly of claim 11, wherein:
the first component includes a first retaining feature;
the second component includes a second retaining feature; and
the first retaining feature is configured to hold the second retaining feature in the initial configuration and to release the second retaining feature upon application of a force in the first direction.

14. The attachment assembly of claim 11, wherein:
the second component includes a distal projection extending in a second direction opposite the first direction and configured for insertion in a hole in a wall; and
the distal projection includes a deformable radially-outward extension configured to engage a backside of the wall.

15. The attachment assembly of claim 11, wherein the second component includes inward-extending arms that terminate at a central passageway.

16. A vehicle comprising:
a coolant system including a hose; and
an attachment assembly comprising:
a first component having a scannable feature; and
a second component including a ring portion engaging the hose and having a shield portion and a window; wherein:
the first component is movable relative to the second component in a first direction from an initial configuration to an attached configuration;
in the initial configuration the scannable feature is received within the second component and the shield portion covers the scannable feature; and
in the attached configuration, the scannable feature is revealed by the window.

17. The vehicle of claim 16, further comprising a wall formed with a hole extending from a first surface of the wall to an opposite second surface of the wall, wherein:
the second component includes a distal projection extending through the hole;
the distal projection includes a radially-outward extension having a diameter greater than a diameter of the hole;
the shield portion abuts the first surface of the wall; and
the first component abuts the first surface of the wall.

18. The vehicle of claim 16, further comprising a stud extending from a surface; wherein
the second component includes inward-extending arms that terminate at a central passageway;
the stud passes through the central passageway; and
the first component abuts the surface.

19. The vehicle of claim 16, wherein:
the first component includes a first locking feature;
the second component includes a second locking feature; and
the first locking feature is configured to engage the second locking feature to lock the attachment assembly in the attached configuration.

20. The vehicle of claim 16, wherein:
the first component includes a first retaining feature;
the second component includes a second retaining feature; and
the first retaining feature is configured to hold the second retaining feature in the initial configuration and to release the second retaining feature upon application of a force in the first direction.
